(19) United States
(12) Patent Application Publication
(10) Pub. No.: US 2024/0331681 A1
(43) Pub. Date: Oct. 3, 2024

(54) AUTOMATIC ADAPTATION OF THE SYNTHESIZED SPEECH OUTPUT OF A TRANSLATION APPLICATION

(71) Applicant: GOOGLE LLC, Mountain View, CA (US)

(72) Inventors: Rakesh Iyer, Santa Clara, CA (US); Jeffrey Robert Pitman, Santa Clara, CA (US); Pendar Yousefi, Santa Clara, CA (US); Te I, San Jose, CA (US); Tiruvilwamalai Raman, San Jose, CA (US)

(21) Appl. No.: 18/128,107

(22) Filed: Mar. 29, 2023

(51) Int. Cl. G10L 13/047; G06F 40/58; G10L 13/033; G10L 13/08; G10L 15/00; G10L 15/16; G10L 15/22; G10L 25/90

(52) U.S. Cl. CPC G10L 13/047; G06F 40/58; G10L 13/0335; G10L 13/08; G10L 15/005; G10L 15/16; G10L 15/22; G10L 25/90

(57) ABSTRACT

A computer generated voice can automatically be adapted to be similar to a user's voice. Various implementations include processing audio data capturing a first language spoken utterance to identify one or more pitch characteristics. For example, the one or more pitch characteristics can include an estimated frequency range of the given user's voice. Additionally or alternatively, the system can process the audio data capturing the first language spoken utterance and a set of candidate computer generated voices using a computer generated voice selection model to select a candidate computer generated voice. Various implementations can include automatically modifying the selected candidate computer generated voice based on the one or more pitch characteristics to change the frequency range of the modified computer generated voice based on the user's voice.

### BACKGROUND

The field of computational linguistics includes machine translation, where a spoken utterance and/or a text representation of a spoken utterance are translated from a first language to a second language. For example, the first language representation of the spoken utterance can be processed using a translation model to generate a second language representation of the utterance. For example, a first language text representation of a spoken utterance can be processed using a translation model to generate a second language text representation of the spoken utterance.

Additionally or alternatively, audio data capturing a spoken utterance in the first language can be processed using an automatic speech recognition (ASR) model to generate the first language text representation of the spoken utterance. In some instances, the ASR model can be combined with the translation model. For example, the audio data capturing the spoken utterance in the first language can be processed using the combined ASR and translation model to generate a second language text representation of the spoken utterance.

A speech synthesis model can be used to generate computer generated synthesized speech. A speech synthesis model can process a text representation of a spoken utterance along with a given computer generated voice (e.g., a computer generated speaker embedding) to generate synthesized speech spoken by the given computer generated voice. Some speech synthesis models can process many computer generated voices to generate synthesized speech with each of the corresponding computer generated voices. For example, the synthesized speech model can process a first computer generated voice in generating synthesized speech spoken in a frequency range typically associated with a woman. Similarly, the synthesized speech model can process a second computer generated voice in generating synthesized speech spoken in a frequency range typically associated with a man.

### SUMMARY

Implementations disclosed herein are directed towards automatically adapting a computer generated voice to be similar to a user's voice. In some implementations, the user can speak an utterance in a first language, and the system can generate synthesized speech output of a second language computer generated voice speaking the utterance. In some of those implementations, the system can automatically select a candidate computer generated voice based on the user speaking the utterance. Additionally or alternatively, the system can modify the candidate computer generated voice to be more similar to the voice of the user who spoke the utterance.

For example, Gavin can speak the utterance “set the thermostat to 70 degrees” in English. The system can automatically select a candidate computer generated second language voice based on Gavin's voice. In some implementations, the system can modify the selected candidate computer generated second language voice further based on Gavin's voice. Furthermore, the system can generate synthesized speech of the utterance based on the modified second language voice.

In some implementations, the system can process at least a portion of the audio data capturing the first language spoken utterance using a computer generated voice selection model to select the candidate computer generated second language voice from a set of computer generated second language voices. In some of those implementations, the computer generated voice selection model can be a Siamese neural network model. The Siamese neural network model can process at least the portion of the audio data capturing the first language spoken utterance along with each of the computer generated second language voices to generate a similarity score between the user's voice and each corresponding second language computer generated voice. In some of those implementations, the similarity score can be a distance (e.g., a Euclidean distance, a cosine similarity measure, etc.) between an embedding space representation of the user's voice and an embedding space representation of a given candidate second language voice. The system can automatically select the computer generated second language voice that is most similar to the user's voice based on the similarity scores.

For example, the system can process a portion of the audio data of Gavin speaking the utterance “set the thermostat to 70 degrees” in English using the computer generated voice selection model along with two candidate computer generated second language voices, a male computer generated second language voice and a female computer generated second language voice. The system can generate a male similarity score of 0.9 corresponding to the male computer generated second language voice and a female similarity score of 0.5 corresponding to the female computer generated second language voice. In some of those implementations, based on the male similarity score of 0.9 being greater than the female similarity score of 0.5, the system can select the male computer generated second language voice as the computer generated second language voice closest to Gavin's voice.

In some implementations, the system can modify the candidate computer generated second language voice based on the user's voice. For example, the system can identify one or more pitch characteristics corresponding to the user's voice. The one or more pitch characteristics can include a representation of the frequency of a user's voice. The intonation of a user's speech (e.g., the rise and fall of a voice in speaking) can be represented as a pitch contour, where the pitch contour captures the frequency of the speaker's voice. In some implementations, the pitch contour can capture the fundamental frequency of speech. The fundamental frequency of speech can be defined as the lowest frequency of a periodic waveform. For example, a typical adult male can have a fundamental frequency in the range of 85 to 155 Hertz. Similarly, a typical adult female can have a fundamental frequency from 165 to 255 Hertz.

For example, the system can process at least a portion of the audio data capturing Gavin speaking “set the thermostat to 70 degrees” in English to estimate the fundamental frequency of Gavin's voice as the one or more pitch characteristics. In other words, the system can estimate the lowest frequency of waveform corresponding to Gavin's voice, and can use the estimated fundamental frequency corresponding to Gavin's voice to modify the pitch contour(s) of the male computer generated second language voice such that the pitch contour(s) of the male computer generated second language voice are closer in range to the estimated fundamental frequency of Gavin's voice.

Additionally or alternatively, the system can process the audio data capturing the first language utterance to identify one or more emphasis signals in the spoken utterance. Emphasis signals can include prosody which indicates the duration and/or emphasis of phoneme(s) in the spoken utterance. In some implementations, the speaker can increase the duration of one or more of the phonemes in the spoken utterance in the first language to denote emphasis. For example, Gavin can speak “set the thermostat to 70 DEEGREEES” in English, where the one or more phonemes in the word degrees to are elongated in duration to denote emphasis. However, the emphasis signals do not directly transfer between languages, and the effect of emphasizing a word by extending its duration in the first language can manifest as repeating a set of words in the second language. For example, when the utterance “set the thermostat to 70 DEEGREEES” is translated to German, the German representation of the emphasized word ‘DEEGREEES’ may include the repetition of one or more phonemes, word pieces, words, etc.

In some implementations, the audio data capturing the spoken utterance in the first language can be processed using an automatic speech recognition (ASR) model to generate a first language text representation of the spoken utterance. Additionally or alternatively, the first language text representation of the spoken utterance can be processed using a translation model to generate a second language text representation of the spoken utterance. For example, the audio data capturing Gavin speaking “set the thermostat to 70 degrees” in English language can be processed using the ASR model to generate an English text representation of “set the thermostat to 70 degrees”. Furthermore, the English text representation of “set the thermostat to 70 degrees” can be processed using the translation model to generate a German language text representation of the spoken utterance “set the thermostat to 70 degrees”.

In some implementations, the system can generate synthesized speech of the second language text representation of the spoken utterance based on processing (1) the second language text representation of the spoken utterance, (2) the modified computer generated second language voice, and (3) the one or more emphasis signals using a speech synthesis model. For example, the system can (1) process the German language text representation of the utterance “set the thermostat to 70 degrees”, (2) the modified male computer generated second language voice with the pitch contour adjusted based on the estimated fundamental frequency of Gavin's voice, and (3) the one or more emphasis signals corresponding to the elongation of the word “DEEGREEES” when spoken by Gavin in the English language using the speech synthesis model to generate the synthesized speech of the German language text representation of “set the thermostat to 70 degrees”.

Accordingly, various implementations set forth techniques for automatically selecting a candidate second language computer generated voice that is similar to a human speaker. Additionally or alternatively, the system automatically modifies the candidate computer generated second language voice by adjusting one or more pitch characteristics such that the frequency range of the modified second language computer generated voice is more similar to the human speaker. Synthesized speech output that is similar to the speaker can enable the user to understand the synthesized speech output more easily. Similarly, when the user understands the synthesized speech output, the user does not have to speak additional utterance(s) and/or wait for additional synthesized speech output in performance of an action. In other words, the system does not need to use computing resources (e.g., processor cycles, memory, battery power, etc.) to process one or more additional turns in the conversation.

The above description is provided only as an overview of some implementations disclosed herein. These and other implementations of the technology are disclosed in additional detail below. It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A illustrates an example of automatically modifying a computer generated second language voice based on pitch characteristic(s) of a human speaker's voice in accordance with various implementations disclosed herein.

FIG. 1B illustrates an example of generating synthesized speech of a second language text representation of a spoken utterance in accordance with various implementations disclosed herein.

FIG. 2 illustrates an example environment in which various implementations described herein may be implemented.

FIG. 3 is a flowchart illustrating an example process of generating synthesized speech of a second language translation of a spoken utterance in accordance with various implementations disclosed herein.

FIG. 4 is a flowchart illustrating an example process of automatically generating a modified computer generated second language voice in accordance with various implementations disclosed herein.

FIG. 5 illustrates another example environment in which various implementations disclosed herein may be implemented.

FIG. 6 illustrates an example architecture of a computing device.

### DETAILED DESCRIPTION

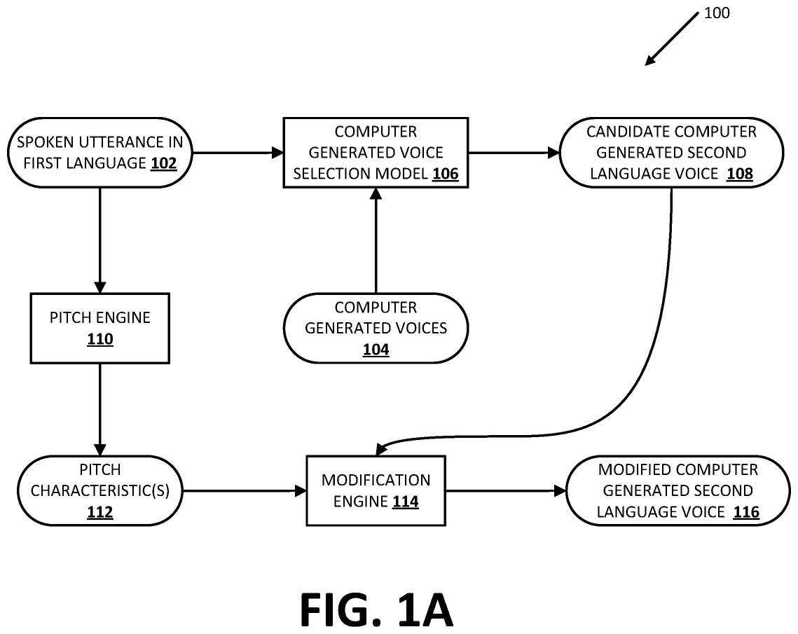

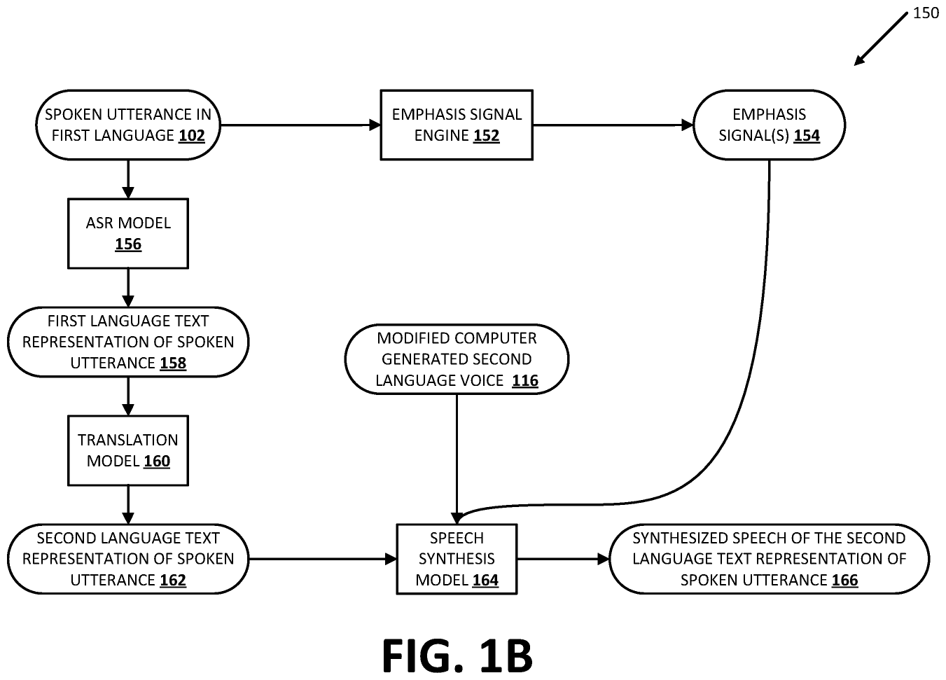

Turning now to the figures, FIG. 1A illustrates an example 100 of automatically modifying a computer generated second language voice based on one or more pitch characteristics of a human speaker. Example 100 includes processing a spoken utterance in a first language 102 and a set of computer generated voices 104 using a computer generated voice selection model 106 to generate a candidate computer generated second language voice 108. In some implementations, the spoken utterance in the first language 102 can be spoken by a human user. For example, one or more microphones can capture audio data of Katherine (the human speaker) speaking the utterance “Assistant, turn on the kitchen light” in English (the first language).

In some implementations, the set of computer generated voices 104 can include one or more computer generated voices. In some of those implementations, the set of computer generated voices 104 can include one or more second language computer generated voices. Additionally or alternatively, the set of computer generated voices can include voices in several languages, such as one or more first language computer generated voices, one or more second language computer generated voices, one or more third language computer generated voices, one or more additional or alternative language computer generated voices, and/or on combinations thereof. In some implementations, the set of computer generated voices 104 can include voices with different frequency ranges. For example, the set of computer generated voices can include one or more computer generated voices in a frequency range typical of male speakers, and one or more computer generated voices in an additional frequency range typical of female speakers.

In some implementations, computer generated voice selection model 106 can be a machine learning model trained to select the computer generated voice, in the set of computer generated voices, most similar to the human speaker. The computer generated voice selection model 106 can include (but is not limited to) a feed forward neural network model, a multilayer perceptron, a recurrent neural network, a transformer network, a convolutional neural network, a Siamese neural network, one or more additional or alternative neural networks, and/or combinations thereof.

A Siamese neural network is an artificial neural network that can use the same weights while working in tandem on two different input vectors to compute comparable output vectors. In some implementations, one of the output vectors can be precomputed, thus forming a baseline against which the other output vector is compared.

For instance, the voice selection model 106 can be a Siamese network which processes a first input vector based on the spoken utterance in the first language 102 and/or a representation of the human speaker of the utterance (not depicted) and one or more second input vectors based on audio data from one or more of the computed generated voices 106. In some implementations, the voice selection model 106 can generate a similarity score between the first input vector (e.g., based on the spoken utterance in the first language 102 and/or a representation of the human speaker of the utterance) and each of the candidate second language computer generated voices. In some of those implementations, the system can automatically select the computer generated voice most similar to the human speaker based on the similarity scores.

Additionally or alternatively, the utterance spoken by the human speaker in the first language 102 and/or one or more voice characteristics of the human speaker (not depicted) can be processed using pitch engine 110 to generate one or more pitch characteristics 112. The intonation of speech (e.g., the rise and fall of a voice in speaking) can be represented as a pitch contour, where the pitch contour can capture the frequency of the speaker's voice. In some implementations, the pitch contour can capture the fundamental frequency of speech. The fundamental frequency of speech can be defined as the lowest frequency of a periodic waveform. For example, a typical adult male can have a fundamental frequency in the range of 85 to 155 Hertz. Similarly, a typical adult female can have a fundamental frequency from 165 to 255 Hertz. In some implementations, the one or more pitch characteristics can include an estimate of the fundamental frequency of the voice of the speaker of the utterance 102.

In some implementations, the candidate computer generated second language voice 108 can be modified by one or more pitch characteristics 112 using modification engine 114 to generate a modified computer generated second language voice 116. For example, the system can rescale the pitch contours of the candidate computer generated second language voice 108 based on the fundamental frequency of the voice of the speaker of the first language utterance 102. In some implementations, rescaling the pitch contours of the candidate computer generated second language voice to a similar range of frequencies of the estimated fundamental frequency of the voice of the speaker of the first language utterance can generate a modified computer generated second language voice 116 that is closer in pitch to the human speaker.

FIG. 1B illustrates an example 150 of generating synthesized speech of the second language text representation of the spoken utterance 166. Example 150 includes processing the spoken utterance in the first language 102 using an ASR model 156 to generate a first language text representation of the spoken utterance 158. The first language text representation of the spoken utterance 158 can be processed using a translation model 160 to generate a second language text representation of the spoken utterance 162.

In some implementations, the ASR model 156 can be an on device ASR model, where the model is stored locally at the client device and/or the processing of the audio data occurs at the client device. Additionally or alternatively, the ASR model 156 can be remote from the client device (e.g., stored at a server remote from the client device) where the audio data is transferred to the location remote from the client device for ASR processing, and the resulting first language text representation of the spoken utterance 158 is transferred back to the client device and/or is further processed at the remote location. Similarly, the translation model 160 can be an on device translation model, where the model is stored locally at the client device and/or the processing of the audio data occurs at the client device. Additionally or alternatively, the translation model 160 can be remote from the client device (e.g., stored at a server remote from the client device). In some implementations, the system can transfer the first language text representation of the spoken utterance 158 to the location of the translation model 160 for processing to generate the second language text representation of the spoken utterance 162. In some other implementations, the ASR model 156 and translation model 160 can be at the same location, where the first language text representation of the spoken utterance 158 is generated locally to the translation model 160.

In some implementations, the ASR model 156 can be a separate model from the translation model 160, where the system processes the audio data capturing the first language spoken utterance 102 using the ASR model 156 to generate the output of the first language text representation of the spoken utterance 158. Subsequently, the first language text representation of the spoken utterance 158 output can be processed using the translation model 160 to generate the second language text representation of the spoken utterance 162.

Additionally or alternatively, the ASR model 156 can be combined with one or more additional models including translation model 160. For instance, the audio data capturing the spoken utterance in the first language 102 can be processed using the combined ASR model and translation model 160 to generate the second language text representation of the spoken utterance 162. In some of those implementations, the system can generate the first language text representation of the spoken utterance 158 an intermediate step while generating the second language text representation of the spoken utterance 162. In some other implementations, the system can directly generate the second language text representation of the spoken utterance 162 based on processing the audio data capturing the spoken utterance in the first language 102, without generating the first language text representation of the spoken utterance 158. In other words, the combined ASR model 156 and translation model 160 can both generate a text representation of the spoken utterance while translating the first language spoken utterance to the second language.

Additionally or alternatively, the audio data capturing the spoken utterance in the first language 102 can be processed using emphasis signal engine 152 to generate one or more emphasis signals 154. In some implementations, the one or more emphasis signals can include prosody signal(s). Prosody includes the duration of the phonemes in the speech and the emphasis. The duration of one or more phonemes in a spoken utterance can be used by the human speaker to denote emphasis. However, the emphasis from the duration of spoken phonemes does not necessarily directly transfer between languages. For example, the effect of emphasizing a word by extending its duration in the first language could manifest as replacing a set of words in the second language. In some implementations, the translation model 160 can transfer one or more emphasis signals from the first language text representation of the spoken utterance to the second language text representation of the spoken utterance.

The modified computer generated second language voice 116 (as described herein with respect to FIG. 1A), the second language text representation of the spoken utterance 162, and the one or more emphasis signals 154 can be processed using a speech synthesis model 164 to generate synthesized speech of the second language text representation of the spoken utterance 166.

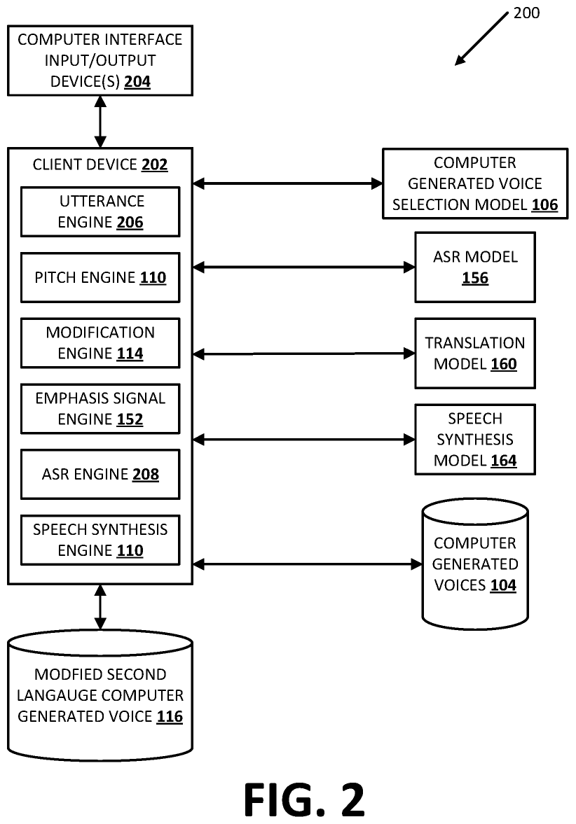

FIG. 2 illustrates a block diagram of an example environment 200 in which various implementations may be implemented. The example environment 200 includes a client device 202 which can include an utterance engine 206, a pitch engine 110, a modification engine 114, an emphasis signal engine 152, an ASR engine 208, a speech synthesis engine 110 and/or one or more additional or alternative engines (not depicted). Additionally or alternatively, client device 202 may be associated with a computer generated voice selection model 106, an ASR model 156, a translation model 160, a speech synthesis model 164, one or more computer generated voices 104, one or more modified second language computer generated voice 116, and/or one or more additional components (not depicted).

In some implementations, client device 202 may include user interface input/output devices 204, which may include, for example, a physical keyboard, a touch screen (e.g., implementing a virtual keyboard or other textual input mechanisms), a microphone, a camera, a display screen, and/or speaker(s). Additionally or alternatively, client device 202 can include a variety of sensors (not depicted) such as an accelerometer, a gyroscope, a Global Positioning System (GPS), a pressure sensor, a light sensor, a distance sensor, a proximity sensor, a temperature sensor, one or more additional sensors, and/or combinations thereof. The user interface input/output devices 204 may be incorporated with one or more client devices 202 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of client device 202 may be implemented on a computing system that also contains the user interface input/output devices 204.

In some implementations client device 202 may include an automated assistant (not depicted), and all or aspects of the automated assistant may be implemented on computing device(s) that are separate and remote from the client device that contains the user interface input/output devices (e.g., all or aspects may be implemented “in the cloud”). In some of those implementations, those aspects of the automated assistant may communicate with the computing device via one or more networks such as a local area network (LAN) and/or a wide area network (WAN) (e.g., the Internet).

Some non-limiting examples of client device 202 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Client device 202 may include one or more memories for storage of data and software applications, one or more processors for accessing data and executing applications, and other components that facilitate communication over a network. The operations performed by client device 202 may be distributed across multiple computing devices. For example, computing programs running on one or more computers in one or more locations can be coupled to each other through a network.

In some implementations, the system can identify audio data capturing a spoken utterance in a first language using utterance engine 206 spoken by a user. For example, the system can capture the spoken utterance via one or more microphones of computer interface input/output devices 204. Additionally or alternatively, the system can process the audio data capturing the first language spoken utterance and the set of computer generated voices 104 using a computer generated voice selection model 106 to select a candidate computer generated second language voice. In some implementations, the system can use a computer generated voice selection model 106 described herein with respect to FIG. 1A. In some implementations, the system can use the set of computer generated voices 104 described herein with respect to FIG. 1A.

In some implementations, the system can use pitch engine 110 to identify one or more pitch characteristics corresponding to the voice of the user who spoke the utterance in the first language. For example, the system can process the spoken utterance in the first language using the pitch engine 110 to generate an estimated fundamental frequency of the voice of the given speaker. In some implementations, the system can use the pitch engine 110 described herein with respect to FIG. 1A.

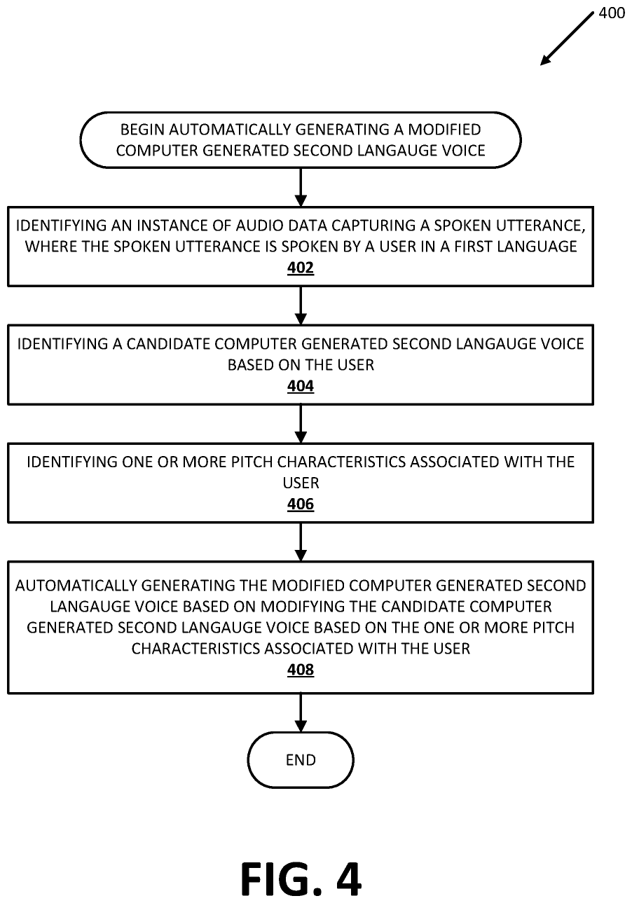

In some implementations, the system can use modification engine 114 to modify the candidate computer generated second language voice (e.g., the candidate computer generated second language voice selected using utterance engine 206) based on the one or more pitch characteristics (e.g., one or more pitch characteristics generated using pitch engine 110) to generate the modified second language computer generated voice 116. In some implementations, the system can generate the modified second language computer generated voice 116 described herein with respect to FIG. 1A. Additionally or alternatively, in some implementations, the system can store a modified second language computer generated voice corresponding to a given user (e.g., the modified second language computer generated voice can be associated with a given user in a user profile). In some of those implementations, modification engine 114 can determine whether there is a previously generated modified second language computer generated voice 116 corresponding to the speaker of the first language utterance. In some implementations, the system can automatically generate the modified computer language second language computer generated voice in accordance with process 400 described herein with respect to FIG. 4.

In some implementations, the system can process the audio data capturing the first language spoken utterance using emphasis signal engine 152 to generate one or more emphasis signals. In some implementations, the system can use emphasis signal engine 152 described herein with respect to FIG. 1B.

In some implementations, the system can use ASR engine 208 to generate a first language text representation of the spoken utterance. For example, ASR engine 208 can process the audio data capturing the first language spoken utterance using ASR model 156. Additionally or alternatively, in some implementations ASR engine 208 can be used to generate a second language text representation of the spoken utterance. For example, ASR engine 208 can process the first language text representation of the spoken utterance using the translation model 160 to generate a second language text representation of the spoken utterance. In some implementations, the system can use ASR model 156 described herein with respect to FIG. 1B. In some implementations, the system can use translation model 160 described herein with respect to FIG. 1B.

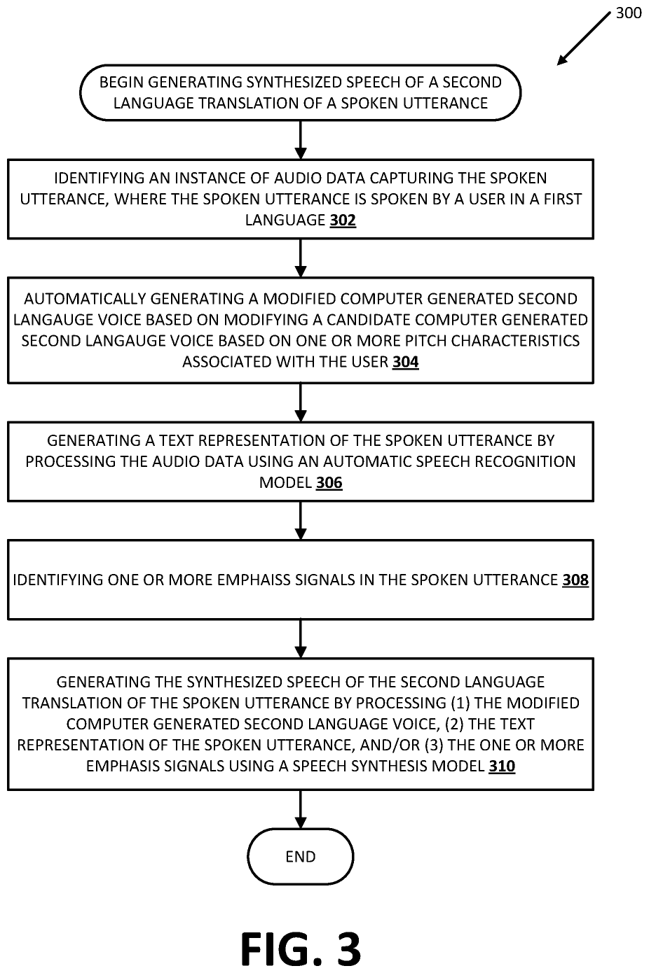

In some implementations, the system can use speech synthesis engine 110 to generate computer generated second language synthesized speech output. In some implementations, the system can process (1) the second language text representation of the spoken utterance (e.g., the second language text representation of the spoken utterances generated using translation model 160) (2) the modified second language computer generated voice 116 corresponding to the user who spoke the first language spoken utterance (e.g., the modified second language computer generated voice 116 generated using modification engine 114), and (3) the one or more emphasis signals (e.g., the one or more emphasis signals generated using emphasis signal engine 152) using the speech synthesis model 164 to generate the computer generated second language synthesized speech output. In some implementations, the system can use speech synthesis model 164 described herein with respect to FIG. 1B. Additionally or alternatively, the system can generate the synthesized speech of the second language text representation of the spoken utterance in accordance with process 300 described herein with respect to FIG. 3.

FIG. 3 is a flowchart illustrating an example process 300 generating synthesized speech of a second language translation of a spoken utterance in accordance with various implementations disclosed herein. For convenience, the operations of the flowchart are described with reference to a system that performs the operations. This system may include various components of various computer systems, such as one or more components of client device 202, client device 502, and/or computing system 610. Moreover, while operations of process 300 are shown in a particular order, this is not meant to be limiting. One or more operations may be reordered, omitted, and/or added.

At block 302, the system identifies an instance of audio data capturing the spoken utterance, where the spoken utterance is spoken by a user in a first language. In some implementations, the system captures the audio data via one or more microphones of a client device (e.g., one or more microphones 204 of client device 202 described herein with respect to FIG. 2). For example, the system can capture Katherine speaking the utterance “turn OFF the kitchen lights” in English.

At block 304, the system automatically generates a modified computer generated second language voice based on modifying a candidate computer generated second language voice based on one or more pitch characteristics associated with the user. In some implementations, the system can automatically generate the modified computer generated second language voice in accordance with process 400 of FIG. 4 described herein. For example, the system can process at least a portion of the spoken utterance “turn OFF the kitchen lights” spoken by Katherine to generate the modified computer generated second language voice

At block 306, the system generates a text representation of the spoken utterance by processing the audio data using an automatic speech recognition (ASR) model. In some implementations, the system can process the audio data capturing the spoken utterance using the ASR model (e.g., the ASR model 156 described herein) to generate a text representation of the spoken utterance in the first language. In some of those implementations, the system can process the first language text representation of the spoken utterance using a translation model (e.g., the translation model 160 disclosed herein) to generate a second language text representation of the spoken utterance. For example, the system can process the audio data capturing Katherine speaking the utterance “turn OFF the kitchen lights” in English using the ASR model to generate a text representation of the utterance in English. Additionally or alternatively, the system can process the English text representation of the utterance using a French translation model to generate a French text representation of the utterance.

In some other implementations, the ASR model can be combined with the translation model. In other words, the combined ASR and translation model can process the audio data capturing the first language spoken utterance to generate a second language text representation of the spoken utterance, without generating the intermediate step of the first language text representation of the utterance. For example, the system can process the audio data capturing Katherine speaking the utterance “turn OFF the kitchen lights” in English using the combined ASR and translation model to generate output of a French text representation of the spoken utterance.

At block 308, the system identifies one or more emphasis signals in the spoken utterance. In some implementations, the one or more emphasis signals can include one or more prosody signals. Prosody signals can include the duration of phonemes in the spoken utterance. In some implementations, a user can speak phoneme(s) in the spoken utterance for a longer duration to add emphasis to the portion of the utterance. For example, Katherine can speak phoneme(s) in the word ‘OFF’ in a longer duration to add emphasis in the utterance “turn OFF the kitchen lights”.

At block 310, the system generates the synthesized speech of the second language translation of the spoken utterance by processing (1) the modified computer generated second language voice, (2) the second language text representation of the spoken utterance, and/or (3) the one or more emphasis signals using a speech synthesis model.

FIG. 4 is a flowchart illustrating an example process 400 of automatically generating a modified computer generated second language voice in accordance with various implementations disclosed herein. For convenience, the operations of the flowchart are described with reference to a system that performs the operations. This system may include various components of various computer systems, such as one or more components of client device 202, client device 502, and/or computing system 610. Moreover, while operations of process 400 are shown in a particular order, this is not meant to be limiting. One or more operations may be reordered, omitted, and/or added.

At block 402, the system identifies an instance of audio data capturing a spoken utterance, where the spoken utterance is spoken by a user in a first language. In some implementations, the system captures the audio data via one or more microphones of a client device (e.g., one or more microphones 204 of client device 202 described herein with respect to FIG. 2). In furtherance of the example described herein with respect to process 300 of FIG. 3, the system can, for example, capture Katherine speaking the utterance “turn OFF the kitchen lights” in English.

At block 404, the system identifies a candidate computer generated second language voice based on the user. In some implementations, the system can process at least a portion of the audio data capturing the human speaking the utterance using a computer generated voice selection model. For example, the system can process at least a portion of the audio data capturing the utterance using the computer generated voice selection model 106 described herein. In some implementations, the system can process all of the audio data using the computer generated voice selection model. In some other implementations, the system can process a portion of the audio data capturing the utterance using the computer generated voice selection model. For example, the system can process 0.5 seconds, 1 second, 2 seconds, 5 seconds, and/or one or more additional length portions of the audio data using the computer generated voice selection model.

In some implementations, the system can process at least a portion of the audio data capturing the first language utterance along with one or more candidate computer generated second language voices and generate a similarity score between the voice of the human speaker of the utterance and each of the candidate computer generated second language voices. The computer generated voice selection model can include a variety of machine learning models such as (but not limited to) a feedforward neural network, a multilayer perceptron, a recurrent neural network, a transformer network, a convolutional neural network, a Siamese neural network, one or more additional or alternative neural networks, and/or combinations thereof.

In some implementations, the computer generated voice selection model can be a Siamese neural network model, where the audio data capturing the first language utterance can be processed using one side of the network, and the candidate computer generated second language voices can be processed using the other side of the network to generate a similarity score between the human speaker and each of the candidate computer generated second language voices. In some implementations, each of the similarity scores can be a distance between an embedding representation of the human speaker's voice and an embedding representation of each of the computer generated second language voices.

The system can process other representations of the human speaker's voice alternatively to and/or in addition to at least a portion of the audio data capturing the utterance spoken by the user. For example, the system can identify the speaker of the utterance as a known human speaker and can process a speaker embedding corresponding to the identified speaker in place of or in addition to the portion of audio data capturing the spoken utterance. The corresponding to a given user can be generated based on processing one or more utterances spoken by the given user using a speaker identification model. In some implementations, the text dependent speaker embedding can be generated using a text dependent speaker identification model, where the speaker embedding is based on the given user speaking one or more predefined utterances. For example, the user can speak “Assistant”, “Hey Assistant”, or “OK Assistant” when invoking an automated assistant. The text dependent speaker embedding can be generated by processing one or more instances of the given user speaking “Assistant”, “Hey Assistant”, or “OK Assistant”. Additionally or alternatively, the speaker embedding can be generated using a text independent speaker identification model, where the text independent speaker embedding is based on a given user speaking an utterance that is not predefined in the system while training the text independent speaker identification model. For example, the text independent speaker embedding can be generated by processing one or more instances of the user speaking “Assistant, turn off the lights”, “OK Assistant, what is the weather”, “OK Assistant, play rock music”, one or more additional or alternative utterances, and/or combinations thereof, using the text independent speaker embedding model.

In some implementations, when the identified speaker of the utterance is a known speaker, the system can select the candidate computer generated second language voice based on a previously selected computer generated voice. For example, a user profile corresponding with the identified known user can include an indication of one or more previously selected computer generated second language voices. In other words, the system may not need to repeat processing to identify the candidate computer generated second language voice if the system has previously identified a candidate computer generated second language voice for the user.

At block 406, the system identifies one or more pitch characteristics associated with the user. In some implementations, the pitch characteristics can represent the intonation of speech of the user, such as the rise and fall of the user's voice while speaking). In some implementations, a pitch contour can capture the frequency of the user's voice. In some of those implementations, the pitch contour can capture the lowest frequency of a periodic waveform of a user's speech (e.g., a fundamental frequency of the user's speech). For example, a typical adult male can have a fundamental frequency in the range of 85 to 155 Hertz. Similarly, a typical adult female can have a fundamental frequency from 165 to 255 Hertz. In some implementations, the one or more pitch characteristics can include an estimate of the fundamental frequency of the voice of the speaker of the utterance.

At block 408, the system automatically generates the modified computer generated second language voice based on modifying the candidate computer generated second language voice based on the one or more pitch characteristics associated with the user. For example, the system can modify the frequency of the computer generated second language voice based on the estimate of the fundamental frequency of the speaker of the utterance. In other words, the candidate computer generated second language voice can be modified to sound more similar to the speaker's voice by adjusting the frequency of the candidate computer generated second language voice.

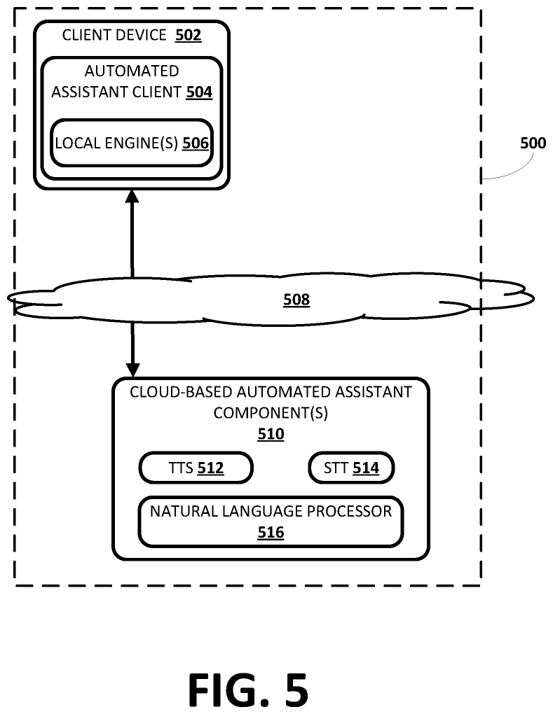

Turning now to FIG. 5, an example environment is illustrated where various implementations can be performed. FIG. 5 is described initially, and includes a client computing device 502, which executes an instance of an automated assistant client 504. One or more cloud-based automated assistant components 510 can be implemented on one or more computing systems (collectively referred to as a “cloud” computing system) that are communicatively coupled to client device 502 via one or more local and/or wide area networks (e.g., the Internet) indicated generally at 508.

An instance of an automated assistant client 504, by way of its interactions with one or more cloud-based automated assistant components 510, may form what appears to be, from the user's perspective, a logical instance of an automated assistant 500 with which the user may engage in a human-to-computer dialog. An instance of such an automated assistant 500 is depicted in FIG. 5. It thus should be understood that in some implementations, a user that engages with an automated assistant client 504 executing on client device 502 may, in effect, engage with his or her own logical instance of an automated assistant 500. For the sakes of brevity and simplicity, the term “automated assistant” as used herein as “serving” a particular user will often refer to the combination of an automated assistant client 504 executing on a client device 502 operated by the user and one or more cloud-based automated assistant components 510 (which may be shared amongst multiple automated assistant clients of multiple client computing devices). It should also be understood that in some implementations, automated assistant 500 may respond to a request from any user regardless of whether the user is actually “served” by that particular instance of automated assistant 500.

The client computing device 502 may be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device). Additional and/or alternative client computing devices may be provided. In various implementations, the client computing device 502 may optionally operate one or more other applications that are in addition to automated assistant client 504, such as a message exchange client (e.g., SMS, MMS, online chat), a browser, and so forth. In some of those various implementations, one or more of the other applications can optionally interface (e.g., via an application programming interface) with the automated assistant 500, or include their own instance of an automated assistant application (that may also interface with the cloud-based automated assistant component(s) 510).

Automated assistant 500 engages in human-to-computer dialog sessions with a user via user interface input and output devices of the client device 502. To preserve user privacy and/or to conserve resources, in many situations a user must often explicitly invoke the automated assistant 500 before the automated assistant will fully process a spoken utterance. The explicit invocation of the automated assistant 500 can occur in response to certain user interface input received at the client device 502. For example, user interface inputs that can invoke the automated assistant 500 via the client device 502 can optionally include actuations of a hardware and/or virtual button of the client device 502. Moreover, the automated assistant client can include one or more local engines 506, such as an invocation engine that is operable to detect the presence of one or more spoken invocation phrases. The invocation engine can invoke the automated assistant 500 in response to detection of one of the spoken invocation phrases. For example, the invocation engine can invoke the automated assistant 600 in response to detecting a spoken invocation phrase such as “Hey Assistant,” “OK Assistant”, and/or “Assistant”. The invocation engine can continuously process (e.g., if not in an “inactive” mode) a stream of audio data frames that are based on output from one or more microphones of the client device 502, to monitor for an occurrence of a spoken invocation phrase. While monitoring for the occurrence of the spoken invocation phrase, the invocation engine discards (e.g., after temporary storage in a buffer) any audio data frames that do not include the spoken invocation phrase. However, when the invocation engine detects an occurrence of a spoken invocation phrase in processed audio data frames, the invocation engine can invoke the automated assistant 500. As used herein, “invoking” the automated assistant 500 can include causing one or more previously inactive functions of the automated assistant 500 to be activated. For example, invoking the automated assistant 500 can include causing one or more local engines 506 and/or cloud-based automated assistant components 610 to further process audio data frames based on which the invocation phrase was detected, and/or one or more following audio data frames (whereas prior to invoking no further processing of audio data frames was occurring).

The one or more local engine(s) 506 of automated assistant 500 are optional, and can include, for example, the augmentation engine, the loss engine, the transcript engine, and the unintentional memorization engine described above, a local voice-to-text (“STT”) engine (that converts captured audio to text), a local text-to-speech (“TTS”) engine (that converts text to speech), a local natural language processor (that determines semantic meaning of audio and/or text converted from audio), and/or other local components. Because the client device 502 is relatively constrained in terms of computing resources (e.g., processor cycles, memory, battery, etc.), the local engines 506 may have limited functionality relative to any counterparts that are included in cloud-based automated assistant components 510.

Cloud-based automated assistant components 510 leverage the virtually limitless resources of the cloud to perform more robust and/or more accurate processing of audio data, and/or other user interface input, relative to any counterparts of the local engine(s) 506. Again, in various implementations, the client device 502 can provide audio data and/or other data to the cloud-based automated assistant components 510 in response to the invocation engine detecting a spoken invocation phrase, or detecting some other explicit invocation of the automated assistant 500.

The illustrated cloud-based automated assistant components 510 include a cloud-based TTS module 512, a cloud-based STT module 514, a natural language processor 516, a dialog state tracker 518, and a dialog manager 520. In some implementations, one or more of the engines and/or modules of automated assistant 500 may be omitted, combined, and/or implemented in a component that is separate from automated assistant 500. Further, in some implementations automated assistant 500 can include additional and/or alternative engines and/or modules. Cloud-based STT module 514 can convert audio data into text, which may then be provided to natural language processor 516.

Cloud-based TTS module 512 can convert textual data (e.g., natural language responses formulated by automated assistant 500) into computer-generated speech output. In some implementations, TTS module 512 may provide the computer-generated speech output to client device 502 to be output directly, e.g., using one or more speakers. In other implementations, textual data (e.g., natural language responses) generated by automated assistant 500 may be provided to one of the local engine(s) 506, which may then convert the textual data into computer-generated speech that is output locally.

Natural language processor 516 of automated assistant 500 processes free form natural language input and generates, based on the natural language input, annotated output for use by one or more other components of the automated assistant 500. For example, the natural language processor 516 can process natural language free-form input that is textual input that is a conversion, by STT module 514, of audio data provided by a user via client device 502. The generated annotated output may include one or more annotations of the natural language input and optionally one or more (e.g., all) of the terms of the natural language input.

In some implementations, the natural language processor 516 is configured to identify and annotate various types of grammatical information in natural language input. In some implementations, the natural language processor 516 may additionally and/or alternatively include an entity tagger (not depicted) configured to annotate entity references in one or more segments such as references to people (including, for instance, literary characters, celebrities, public figures, etc.), organizations, locations (real and imaginary), and so forth. In some implementations, the natural language processor 516 may additionally and/or alternatively include a coreference resolver (not depicted) configured to group, or “cluster,” references to the same entity based on one or more contextual cues. For example, the coreference resolver may be utilized to resolve the term “there” to “Hypothetical Café” in the natural language input “I liked Hypothetical Café last time we ate there.” In some implementations, one or more components of the natural language processor 516 may rely on annotations from one or more other components of the natural language processor 516. In some implementations, in processing a particular natural language input, one or more components of the natural language processor 516 may use related prior input and/or other related data outside of the particular natural language input to determine one or more annotations.

In some implementations, dialog state tracker 518 may be configured to keep track of a “dialog state” that includes, for instance, a belief state of a one or more users' goals (or “intents”) over the course of a human-to-computer dialog session and/or across multiple dialog sessions. In determining a dialog state, some dialog state trackers may seek to determine, based on user and system utterances in a dialog session, the most likely value(s) for slot(s) that are instantiated in the dialog. Some techniques utilize a fixed ontology that defines a set of slots and the set of values associated with those slots. Some techniques additionally or alternatively may be tailored to individual slots and/or domains. For example, some techniques may require training a model for each slot type in each domain.

Dialog manager 520 may be configured to map a current dialog state, e.g., provided by dialog state tracker 518, to one or more “responsive actions” of a plurality of candidate responsive actions that are then performed by automated assistant 500. Responsive actions may come in a variety of forms, depending on the current dialog state. For example, initial and midstream dialog states that correspond to turns of a dialog session that occur prior to a last turn (e.g., when the ultimate user-desired task is performed) may be mapped to various responsive actions that include automated assistant 500 outputting additional natural language dialog. This responsive dialog may include, for instance, requests that the user provide parameters for some action (i.e., fill slots) that dialog state tracker 518 believes the user intends to perform. In some implementations, responsive actions may include actions such as “request” (e.g., seek parameters for slot filling), “offer” (e.g., suggest an action or course of action for the user), “select,” “inform” (e.g., provide the user with requested information), “no match” (e.g., notify the user that the user's last input is not understood), a command to a peripheral device (e.g., to turn off a light bulb), and so forth.

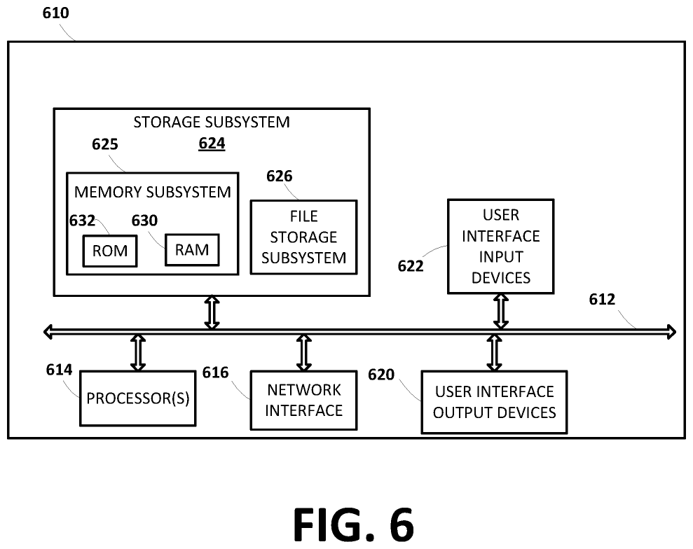

FIG. 6 is a block diagram of an example computing device 610 that may optionally be utilized to perform one or more aspects of techniques described herein. In some implementations, one or more of a client computing device, and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of one or more of the processes of FIG. 3 and/or FIG. 5, as well as to implement various components depicted in FIG. 2 and/or FIG. 5.

These software modules are generally executed by processor 614 alone or in combination with other processors. Memory 625 used in the storage subsystem 624 can include a number of memories including a main random access memory (“RAM”) 630 for storage of instructions and data during program execution and a read only memory (“ROM”) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes identifying an instance of audio data capturing a spoken utterance, where the spoken utterance is spoken by a user in a first language. In some implementations, the method includes processing the instance of audio data to automatically generate output that includes synthesized speech, of a second language translation of the spoken utterance, generated by a modified text to speech (TTS) computer generated second language voice, wherein processing the instance of the audio data to automatically generate output that includes the synthesized speech, of the second language translation of the spoken utterance, generated by the modified TTS computer generated second language voice includes identifying a candidate TTS computer generated second language voice based on the user. In some implementations, the method includes identifying one or more pitch characteristics associated with the user. In some implementations, the method includes generating the modified TTS computer generated second language voice by modifying the candidate TTS computer generated second language voice based on the one or more pitch characteristics associated with the user. In some implementations, the method includes generating the synthesized speech, of the second language translation of the spoken utterance, by processing a text representation of the second language translation of the spoken utterance and the modified TTS computer generated second language voice using a speech synthesis model.

These and other implementations of the technology can include one or more of the following features.

In some implementations, identifying the candidate TTS computer generated second language voice based on the user includes identifying a plurality of candidate TTS computer generated second language voices. In some implementations, the method further includes processing at least a portion of the instance of audio data and the plurality of candidate TTS computer generated second language voices using a TTS computer generated voice selection model to generate similarity output. In some implementations, the method further includes identifying the candidate TTS computer generated second language voice, from the plurality of candidate TTS computer generated second language voices, based on processing the similarity output. In some versions of those implementations, the TTS computer generated voice selection model is a Siamese neural model. In some versions of those implementations, the one or more pitch characteristics include an estimated frequency range of the user's speech, and wherein identifying the one or more pitch characteristics associated with the user includes processing the instance of audio data to generate the estimated frequency range of the user's speech. In some versions of those implementations, the one or more pitch characteristics include the estimated frequency range of the user's speech, and wherein generating the modified TTS computer generated second language voice by modifying the candidate TTS computer generated second language voice based on the one or more pitch characteristics associated with the user includes generating the modified TTS computer generated second language voice by adjusting a frequency range of the candidate TTS computer generated second language voice based on the predicted frequency range of the user's speech.

In some implementations, identifying the candidate TTS computer generated second language voice based on the user includes identifying a plurality of candidate TTS computer generated second language voices. In some implementations, the method further includes processing a speaker embedding of the user and the plurality of candidate TTS computer generated second language voices using a TTS computer generated voice selection model to generate similarity output. In some implementations, the method further includes identifying the candidate TTS computer generated second language voice, from the plurality of candidate TTS computer generated second language voices, based on processing the similarity output. In some versions of those implementations, the speaker embedding is a text independent speaker embedding. In some versions of those implementations, the speaker embedding is a text dependent speaker embedding. In some versions of those implementations, the one or more pitch characteristics include an estimated frequency range of the user's speech, and wherein identifying the one or more pitch characteristics associated with the user includes processing a speaker embedding of the user to identify the estimated frequency range of the user's speech. In some versions of those implementations, the one or more pitch characteristics include the estimated frequency range of the user's speech, and wherein generating the modified TTS computer generated second language voice by modifying the candidate TTS computer generated second language voice based on the one or more pitch characteristics associated with the user includes generating the modified TTS computer generated second language voice by adjusting a frequency range of the candidate TTS computer generated second language voice based on the predicted frequency range of the user's speech.

In some implementations, the text representation of the second language translation of the spoken utterance is generated by processing the instance of audio data capturing the spoken utterance in the first language, using an automatic speech recognition (ASR) model, to generate a text representation of the first language spoken utterance. In some implementations, the method further includes processing the text representation of the first language spoken utterance using a translation model to generate the text representation of the second language translation of the spoken utterance.

In some implementations, the text representation of the second language translation of the spoken utterance is generated by processing the instance of audio data capturing the spoken utterance in the first language, using a combined model to generate the text representation of the second language translation of the spoken utterance, wherein the combined model includes an automatic speech recognition portion and a translation portion.

In some implementations, prior to generating the synthesized speech, of the second language translation of the spoken utterance, the method further includes processing the instance of audio data to identify one or more emphasis signals in the spoken utterance. In some implementations, generating the synthesized speech, of the second language translation of the spoken utterance further includes processing the one or more emphasis signals using the speech synthesis model in generating the synthesized speech, wherein the one or more emphasis signals are processed, using the speech synthesis model, along with the text representation of the second language translation of the spoken utterance and the modified TTS computer generated second language voice. In some versions of those implementations, the one or more emphasis signals are based on an extended duration of one or more phonemes in the first language spoken utterance. In some versions of those implementations, the duration of the one or more phonemes in the first language does not directly translate to an extended duration of one or more phonemes in the synthesized speech.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the methods described herein. Some implementations also include one or more transitory or non-transitory computer readable storage media storing computer instructions executable by one or more processors to perform any of the methods described herein.

What is claimed is:

1. A method implemented by one or more processors, the method comprising:
identifying an instance of audio data capturing a spoken utterance, where the spoken utterance is spoken by a user in a first language;
processing the instance of audio data to automatically generate output that includes synthesized speech, of a second language translation of the spoken utterance, generated by a modified text to speech (TTS) computer generated second language voice, wherein processing the instance of the audio data to automatically generate output that includes the synthesized speech, of the second language translation of the spoken utterance, generated by the modified TTS computer generated second language voice comprises:
identifying a candidate TTS computer generated second language voice based on the user;
identifying one or more pitch characteristics associated with the user;
generating the modified TTS computer generated second language voice by modifying the candidate TTS computer generated second language voice based on the one or more pitch characteristics associated with the user; and
generating the synthesized speech, of the second language translation of the spoken utterance, by processing a text representation of the second language translation of the spoken utterance and the modified TTS computer generated second language voice using a speech synthesis model.

2. The method of claim 1, wherein identifying the candidate TTS computer generated second language voice based on the user comprises:
identifying a plurality of candidate TTS computer generated second language voices;
processing at least a portion of the instance of audio data and the plurality of candidate TTS computer generated second language voices using a TTS computer generated voice selection model to generate similarity output; and
identifying the candidate TTS computer generated second language voice, from the plurality of candidate TTS computer generated second language voices, based on processing the similarity output.

3. The method of claim 2, wherein the TTS computer generated voice selection model is a Siamese neural model.

4. The method of claim 2, wherein the one or more pitch characteristics include an estimated frequency range of the user's speech, and wherein identifying the one or more pitch characteristics associated with the user comprises:
processing the instance of audio data to generate the estimated frequency range of the user's speech.

5. The method of claim 4, wherein the one or more pitch characteristics include the estimated frequency range of the user's speech, and wherein generating the modified TTS computer generated second language voice by modifying the candidate TTS computer generated second language voice based on the one or more pitch characteristics associated with the user comprises:
generating the modified TTS computer generated second language voice by adjusting a frequency range of the candidate TTS computer generated second language voice based on the predicted frequency range of the user's speech.

6. The method of claim 1, wherein identifying the candidate TTS computer generated second language voice based on the user comprises:
identifying a plurality of candidate TTS computer generated second language voices;
processing a speaker embedding of the user and the plurality of candidate TTS computer generated second language voices using a TTS computer generated voice selection model to generate similarity output; and
identifying the candidate TTS computer generated second language voice, from the plurality of candidate TTS computer generated second language voices, based on processing the similarity output.

7. The method of claim 6, wherein the speaker embedding is a text independent speaker embedding.

8. The method of claim 6, wherein the speaker embedding is a text dependent speaker embedding.

9. The method of claim 6, wherein the one or more pitch characteristics include an estimated frequency range of the user's speech, and wherein identifying the one or more pitch characteristics associated with the user comprises:
processing a speaker embedding of the user to identify the estimated frequency range of the user's speech.

10. The method of claim 9, wherein the one or more pitch characteristics include the estimated frequency range of the user's speech, and wherein generating the modified TTS computer generated second language voice by modifying the candidate TTS computer generated second language voice based on the one or more pitch characteristics associated with the user comprises:
generating the modified TTS computer generated second language voice by adjusting a frequency range of the candidate TTS computer generated second language voice based on the predicted frequency range of the user's speech.

11. The method of claim 1, wherein the text representation of the second language translation of the spoken utterance is generated by:
processing the instance of audio data capturing the spoken utterance in the first language, using an automatic speech recognition (ASR) model, to generate a text representation of the first language spoken utterance;
processing the text representation of the first language spoken utterance using a translation model to generate the text representation of the second language translation of the spoken utterance.

12. The method of claim 1, wherein the text representation of the second language translation of the spoken utterance is generated by:
processing the instance of audio data capturing the spoken utterance in the first language, using a combined model to generate the text representation of the second language translation of the spoken utterance, wherein the combined model includes an automatic speech recognition portion and a translation portion.

13. The method of claim 1, further comprising:
prior to generating the synthesized speech, of the second language translation of the spoken utterance, processing the instance of audio data to identify one or more emphasis signals in the spoken utterance; and
wherein generating the synthesized speech, of the second language translation of the spoken utterance further comprises:
processing the one or more emphasis signals using the speech synthesis model in generating the synthesized speech, wherein the one or more emphasis signals are processed, using the speech synthesis model, along with the text representation of the second language translation of the spoken utterance and the modified TTS computer generated second language voice.

14. The method of claim 13, wherein the one or more emphasis signals are based on an extended duration of one or more phonemes in the first language spoken utterance.

15. The method of claim 14, wherein the duration of the one or more phonemes in the first language does not directly translate to an extended duration of one or more phonemes in the synthesized speech.

16. A system comprising:
memory storing instructions;
one or more processors operable to execute the instructions to:
identify an instance of audio data detected via one or more microphones, the instance of audio data capturing a spoken utterance that is spoken by a user in a first language;
process the instance of audio data to automatically generate output that includes synthesized speech, of a second language translation of the spoken utterance, generated by a modified text to speech (TTS) computer generated second language voice, where in processing the instance of the audio data to automatically generate output that includes the synthesized speech, of the second language translation of the spoken utterance, generated by the modified TTS computer generated second language voice one or more of the processors are to:
identify a candidate TTS computer generated second language voice based on the user;
identify one or more pitch characteristics associated with the user;
generate the modified TTS computer generated second language voice by modifying the candidate TTS computer generated second language voice based on the one or more pitch characteristics associated with the user; and
generate the synthesized speech, of the second language translation of the spoken utterance, by processing, using a speech synthesis model:
a text representation of the second language translation of the spoken utterance, and
the modified TTS computer generated second language voice.

17. The system of claim 16, wherein in identifying the candidate TTS computer generated second language voice based on the user one or more of the processors are to:
identify a plurality of candidate TTS computer generated second language voices;
process at least a portion of the instance of audio data and the plurality of candidate TTS computer generated second language voices using a TTS computer generated voice selection model to generate similarity output; and
identify the candidate TTS computer generated second language voice, from the plurality of candidate TTS computer generated second language voices, based on processing the similarity output.

18. The system of claim 16, wherein in identifying the candidate TTS computer generated second language voice based on the user one or more of the processors are to:
identify a plurality of candidate TTS computer generated second language voices;
process a speaker embedding of the user and the plurality of candidate TTS computer generated second language voices using a TTS computer generated voice selection model to generate similarity output; and
identify the candidate TTS computer generated second language voice, from the plurality of candidate TTS computer generated second language voices, based on processing the similarity output.

19. The system of claim 16, wherein the text representation of the second language translation of the spoken utterance is generated by:
processing the instance of audio data capturing the spoken utterance in the first language, using a combined model to generate the text representation of the second language translation of the spoken utterance, wherein the combined model includes an automatic speech recognition portion and a translation portion.

20. The system of claim 16, wherein one or more of the processors are further operable to execute the instructions to:
prior to generating the synthesized speech, of the second language translation of the spoken utterance, process the instance of audio data to identify one or more emphasis signals in the spoken utterance; and
wherein in generating the synthesized speech, of the second language translation of the spoken utterance further one or more of the processors are to:
process the one or more emphasis signals using the speech synthesis model in generating the synthesized speech, wherein the one or more emphasis signals are processed, using the speech synthesis model, along with the text representation of the second language translation of the spoken utterance and the modified TTS computer generated second language voice.
